(19) United States
(12) Patent Application Publication
(10) Pub. No.: US 2003/0096050 A1
(43) Pub. Date: May 22, 2003

(54) Food product

(75) Inventors: Setsujiro Inaoka, Tokyo (JP); Yoshihide Asabu, Tokyo (JP); Koji Hanaoka, Tokyo (JP); Yoshikazu Ogura, Tokyo (JP); Shinichi Meguro, Haga-gun (JP); Tomohito Mizuno, Haga-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kao Corporation, Tokyo (JP)

(21) Appl. No.: 10/145,733

(22) Filed: May 16, 2002

(30) Foreign Application Priority Data
May 16, 2001 (JP) 2001-146169
Mar. 20, 2002 (JP) 2002-078718

(51) Int. Cl. A23F 3/00

(52) U.S. Cl. 426/597

(57) ABSTRACT

A food product containing the following-non-polymerized components (A) and (B):

(A) catechins in an amount of at least 200 ppm

(B) gallic acid or a salt thereof wherein a ratio by weight (B)/{(A)+(B)} is 0.08 to 0.6.

### BACKGROUND OF THE INVENTION

1. Field of the Invention

The present invention relates to a food product which is safe to the human body, exhibits an excellent anti-obesity effect, and has an improved taste.

2. Discussion of the Background

Polyphenols contained in green tea, oolong tea, and black tea (the latter two are categorized as fermented teas), inter alia catechins, have been known to be useful as, for example, an inhibitor against elevation of cholesterol level (Japanese Patent Application Laid-Open (kokai) No. 156614/1985), an amylase inhibitor (Japanese Patent Application Laid-Open (kokai) No. 133928/1991), or a lipid metabolism improving agent (Japanese Patent Application Laid-Open (kokai) No. 322716/1997).

Catechins are also contained in commercial tea-type beverages, and in the case of commercially available green tea beverages they are contained in amounts of 100 to 200 mg per bottle (500 mL). Incidentally, in order for catechins to manifest their effects an lipid metabolism, ingestion in amounts of 300 to 500 mg per day is generally recommended. Studies regarding the anti-obesity effect of catechins in humans have revealed that ingestion of catechins in amounts of 500 mg per day attains a statistically significant effect of inhibiting body weight increase in three months. This means that in order to ensure physiological effects exerted by catechins, commercial green tea beverages must be consumed in a volume of two to three bottles daily. However, in reality, such a volume is far too much for continued daily consumption.

Meanwhile, raising the concentration of catechins contained in food or directly ingesting catechins in powder form is difficult, in consideration of the bitter taste of catechins. In order to mitigate the bitterness and to add attractiveness to catechins in terms of taste, several methods have keen proposed, including chemical modification of catechins with saccharides (Japanese Patent Application Laid-Open (kokai) No 3089/1997). However, insufficient studies have been conducted on physiological effects, percent absorption, and other characteristics of clathrate catechins, chemically modified catechins, or catechins which have undergone other chemical treatments, and in addition, chemical modification or similar means is not necessarily preferred from the viewpoint of food safety.

Accordingly, an object of the present invention is to provide a safe food product which can be ingested daily without raising any problem, and which has an enhanced anti-obesity effect.

### SUMMARY OF THE INVENTION

The present inventors have found that when catechins, which are known to have anti-obesity effect, are used in combination with gallic acid, there can be obtained a food product exhibiting a surprisingly improved anti-obesity effect as compared with the case of the sole use of the respective ingredients. The food product of the invention is further advantageous in that an anti-obesity effect can be obtained by use of a smaller amount of catechins, attractiveness is added in terms of taste and daily ingestion can be continued with ease.

The present invention provides a food product comprising the following non-polymerized components (A) and (B):

(A) catechins in an amount of at least 200 ppm

(B) gallic acid or a salt thereof

wherein a ratio by weight (B)/{(A)+(B)} is 0.08 to 0.6.

Various other objects, features and many of the attendant advantages of the present invention will be readily appreciated as the same becomes better understood by reference to the following detailed description of the preferred embodiments.

### DESCRIPTION OF THE PREFERRED EMBODIMENTS

In the present invention, component (A); i.e., catechins, encompasses the following eight types collectively: catechin, gallocatechin, catechin gallate, gallocatechin gallate, epicatechin, epigallocatechin, epicatechin gallate, and epigallocatechin gallate. Of these, one or more species selected from among non-gallic catechins; i.e., catechin, gallocatechin, epicatechin, and epigallocatechin, are preferred in the practice of the present invention. In this connection, catechin gallates broadly encompass catechin gallate, gallocatechin gallate, epicatechin gallate, and epigallocatechin gallate.

Catechins employable in the present invention include not only commercially available catechin reagents and purified catechins, but also tea extracts and their concentrates. The tea extracts may be obtained from, for example, non-fermented green teas of various types (e.g., sencha, bancha, gyokuro, tenchea, and, kamairi-cha) produced from tea leaves of a variety belonging to genus Camellia, such as C. sinensis or C. assamica, Yaburkita, or a hybrid thereof; semi-fermented teas, which are often collectively called “oolong tea,” including tekkannon and ogonkei: and fermented teas such as Darjeeling, Assam. and Sri Lanka. Specifically, any of these is subjected to extraction, in the presence or absence of an extraction aid, with water or hot water. Water-soluble organic solvents may be employed for producing the tea extracts. The tea concentrates are prepared by concentrating tea extracts by use of, for example, organic solvents, columns, or membranes.

Such concentrates of tea extracts may be obtained by subjecting tea leaves to extraction with hot water or water-soluble organic solvent, then concentrating the resultant extract, and specific methods therefor are disclosed in detail in, for example, Japanese Patent Application Laid-Open (kokai) Nos. 219384/1984, 20589/1992, 260907/1993, and 306279/1993. Examples of commercially available products include “POLYPHENON” (by Tokyo Food Techno Co., Ltd.), “TEAFURAN” (by Ito En, Ltd.), “SUNPHEN” (by Taiyo Kagaku K. K.), and “SUN-OOLONG” (by Suntory, Ltd.). The tea extract concentrates may take a variety of forms, including a solid, an aqueous dispersion, and a slurry. Examples of media employable for dissolving or diluting the tea extract concentrates (hereinafter such media are called “extraction solvents”) include water, carbonated water, and extracted teas prepared through ordinary means.

The catechins (i.e., ingredient (A)) are contained in the food product of the present invention generally in an amount of 200 ppm or more, preferably 400 ppm or more, more preferably 600 ppm or more. Amounts of catechins less than 200 ppm fail to provide a satisfactory anti-obesity effect.

Examples of the salts of gallic acid employable in the present invention include alkali metal salts of gallic acid. The gallic acid may be prepared through chemical synthesis. Alternatively, any naturally occurring product containing gallic acid or an extract of the naturally occurring product may be used as the gallic acid. Examples of such extract include those obtained through extraction of gallnuts found in Rhus jayanica LINNE, gallnuts found in Quercus infectoria, or plants belonging to Caesalipinia spinosa.

Examples of the chemically synthesized products of gallic acid include, but are not limited to, hydrolysis products of the aforementioned catechin gallates. Hydrolysis may be carried out by use of an acid such as sulfuric acid or hydrochloric acid, an alkali such as sodium hydroxide, or an enzyme, or through fermentation. Hydrolysis through fermentation is preferred. Preferably, tannase (tannin acyl hydrase EC3.1.1.20) is employed as the enzyme.

Examples of raw materials which can be used in enzymatic treatment include tea leaves containing catechin gallates, crude drugs containing catechin gallates, and extracts thereof. Particularly, tea leaves and their extracts are preferred.

In the enzymatic treatment, tea leaves, crude drugs, or their extracts are diluted with water and then treated with enzymes. Alternatively, the extracts may be directly subjected to enzymatic treatment. The raw materials which are to undergo reaction may be appropriately heated in advance. After completion of reaction, the enzymes are deactivated by the application of heat and/or regulation of pH. Alternatively, the reaction mixture is purified as is.

In order to obtain a satisfactory anti-obesity effect, gallic acid or a salt thereof (i.e., component (B)) is preferably contained in the food product of the present invention in an amount (as reduced to gallic acid) of 18 ppm or more, preferably 35 ppm or more, most preferably 53 ppm or more.

The ratio by weight of component (B) to components (A) and (B) is as follows: (B)/{(A)+(B)}=0.08 to 0.6. From the viewpoint of reducing the proportions of catechins, bitter ingredients, while maintaining anti obesity effect, the ratio is preferably 0.1 to 0.6, more preferably 0.2 to 0.6.

In the present invention, gallic acid is mixed with catechins by, for example, hydrolyzing catechin gallates to obtain gallic acid, followed by mixing with catechins separately extracted from tea leaves. Alternatively, catechin gallates contained in tea leaves are treated with tannase to thereby convert a portion of or the entirety of catechin gallates into gallic acid, yielding a mixture of catechins and gallic acid.

The food products of the present invention may contain, in addition to catechins and gallic acid, other types of polyphenols. Preferably, the ratio of the total weight of catechins and gallic acid to the total weight of polyphenols is 0.5 to 0.99, more preferably 0.6 to 0.99, most preferably 0.7 to 0.99. When these ranges are met, proportions of catechins (which are non-polymerized products) and the gallic acid contained in total polyphenols virtually increases, to thereby yield an enhanced anti-obesity effect. Total polyphenol content is preferably 400 ppm or more, more preferably 650 ppm or more, most preferably 850 ppm or more, with respect to the entire food product of the present invention. The total polyphenol content is measured by means of colorimetry employing tartaric acid, and as a standard, the ethyl ester of gallic acid.

Examples of the food products of the present invention include beverages containing the above-described ingredients, and many other forms of food products containing these ingredients and ordinarily employed food ingredients in combination, such as liquid-type, emulsion-type, and paste-type foods (e.g., margarine, mayonnaise, processed milk, curry, dressings); semi-solid foods such as jelly or gumi; solid foods such as gum, tofu, diet supplements; and powdery foods. Of these, beverages are preferred.

Catechins and gallic acid are contained in any of the mentioned foods such that their total weight per serving falls within a range of 250 to 1,000 mg, preferably 400 to 850 mg, most preferably 500 to 750 mg, for easy ingestion of these ingredients over long periods of time and ensured anti-obesity effect.

The beverages are preferably contained in sealable containers. When green tea extracts are employed as raw materials of component (A) or gallic acid, use in combination of green tea extracts and oolong tea (semi-fermented tea) or black tea (fermented tea) to thereby provide beverages is particularly preferred. This is because, even when catechin concentration is elevated, the oolong tea or black tea mitigates the bitterness and astringency of catechins, thereby providing an attractive taste. Examples of the container include, but are not limited to, PET bottles, cans, paper containers, high-temperature/high-pressure sterilized pouches and bottles. The beverages contained in sealable containers are preferably those that can be consumed without dilution. Such beverages preferably undergo sterilization or bacteriostatic treatment, and their product forms include liquids of low viscosity, gel-type and high-viscosity liquid-base products whose viscosity has been elevated by use of a thickener such as gelatin. Preferred types of beverages include fermented lactic beverages, yogurt drinks, carbonated beverages, fruit-juice beverages, and their pH values fall within a range of 3 to 6, preferably 3 to 5, particularly preferably 3 to 4.7 which are so-called acid-type beverages charged in containers. These product types are advantageous in terms of taste of the beverage and chemical stability of catechins.

When the ratio by weight in relation to catechins (A) and gallic acid (B), specifically (B)/{(A)+(B)}, falls within a range of 0.08 to 0.6, preferably 0.1 to 0.6, more preferably 0.2 to 0.6, astringency of the beverage is suppressed to thereby provide an improved taste for easy consumption.

The non-polymerized component, catechins, in the beverage are contained in amounts of 200 to 2,400 ppm, preferably 400 to 2,200 ppm more preferably 600 to 2,000 ppm, from the viewpoints of ensured anti-obesity effect attainable from combined use with gallic acid, and better taste for improved attractiveness.

In the case of metallic cans, which can be subjected to sterilization with heat after being charged with beverages, sterilization of the food products of the present invention is carried out so as to be in conformity with relevant provisions of the Food Sanitation Law. In the case of PET bottles and paper containers, which cannot be subjected to sterilization at high temperature and high pressure, the food products to be placed in such containers are sterilized in advance at high temperature and high pressure, for example, sterilized at high temperature for short periods by use of a plate-type heat exchanger and then cooled to a predetermined temperature for charging. Other methods include sterilization with heat under aseptic conditions, followed by returning pH to neutral under aseptic conditions and sterilization with heat under neutral pH conditions, followed by returning pH to an acidic value under aseptic conditions.

Compositions containing components (A) and (B) at a weight ratio falling within the above-defined ranges find utility as anti-obesity drugs, because of their excellent anti-obesity effect, high safety, and high compliance. When the compositions are used as medicines, preferably, the components (A) and (B) are formulated in combination with a pharmacologically acceptable carrier into oral preparations or parenteral preparations. Oral preparations are preferred. Product forms of oral preparations include tablets, granules, fine granules, pills, powders, soft capsules, hard capsules, troches, chewable drugs, liquids and solutions.

Having generally described this invention, a further understanding can be obtained by reference to certain specific examples which are provided herein for purposes of illustration only and are not intended to be limiting unless otherwise specified.

### EXAMPLES

The amounts of catechins, gallic acid, and total polyphenols contained in drugs or foods of the present invention are determined as follows.

Catechins and Gallic Acid

A sample which has passed through a filter (0.8 μm) is applied onto a column (4.6 mm φ×250 mm; Octadecyl-group-introduced packed column for liquid chromatography. L-COLUMN TM ODS; manufactured by Chemicals Evaluation and Research Institute, Japan) for high performance liquid chromatography (model SCL-AVP, manufactured by Shimadzu Corporation) at a column temperature of 35° C. The gradient method is employed, with mobile phase solution A being 0.1 mol/L acetic acid in distilled water and solution B being 0.1 mol/L acetic acid in acetonitrile. The amount of sample applied is 20 μL, and detection with a UV detector is carried out at a wavelength of 280 nm.

Total Polyphenols

The total polyphenol content is determined by means of the iron tartarate method, in which ethyl gallate is used for the preparation of a standard solution, and the data are converted to gallic acid equivalents (see “Green Tea Polyphenols,” in Effective Utilization Techniques of Functional Materials for Foods and Beverages, Series No. 10). Specifically, a sample (5 mL) is allowed to develop color with a standard solution containing iron tartarate. By use of a phosphate buffer, the volume of the sample is adjusted to 25 mL. Absorbence is measured at 540 nm, and from a calibration curve obtained from ethyl gallate, total polyphenol content is determined.

<Preparation of phosphate buffer>1/15 M disodium hydrogenphosphate solution and 1/15 M sodium dihydrogenphosphate solution are mixed to adjust the pH of the mixture to 7.5.

### Example 1

Fifty grams of catechins *⁾ containing catechin gallates and nongallic catechins (*⁾ trade name: POLYPHENONHG, manufactured by Tokyo Food Techno Co., Ltd.) and 0.1 g of tannase (trade name: TANNASE SANKYO, manufactured by Sankyo) were added to 1,949 g of distilled water, and the mixture was allowed to react at 35° C. for 2 hours (in the case of Invention Product 1) or for 4 hours (in the case of Invention Product 2). After completion of the reaction, the reaction mixture was freeze-dried, and the gallic acid content, catechin content, and total polyphenol content in the freeze-dried samples were determined. The results are shown in Table 1.

TABLE 1

| | | Invention Product | | Comparative |
|---|---|---|---|---|
| | | 1 | 2 | Product |
| (A) | Catechins (wt %) | 31.1 | 28.9 | 33.5 |
| | Non-gallic catechins (wt %) | 20.6 | 25.4 | 16.5 |
| (B) | Gallic acid (wt %) | 3.4 | 5.8 | 1.4 |
| | Total polyphenols (wt %) | 42.7 | 42.4 | 42.8 |
| | (B){(A) + (B)} | 0.1 | 0.17 | 0.04 |

(Note)
Inventive Product 1: Two-hour reaction product
Invention Product 2: Four-hour reaction product
Comparative Product: Raw material catechin (POLYPHENON HG)

### Example 2

By use of the compositions prepared in Example 1 (catechin hydrolyzates), obesity preventive effect of the compositions of the present invention was investigated in mice as described below.

| | |
|---|---|
| Animals employed: | 7-week-old male mice C57BL/6J (CLEA Japan, |
| | Inc.) |
| Breeding conditions: | Room temperature 23 ± 20° C., |
| | Relative humidity 55 ± 10% |
| | Light irradiation: from 7 to 19 PM |

Test: The mice were grouped at random (10 mice/group) and fed the feeds shown in Table 2 ad libitum for 11 weeks. The body weight of each mouse and the amount of feed intake per cage were checked once a week. Upon elapse of the 11 weeks, each mouse was fasted for 12 hours, and his abdomen was immediately cut-open under etherization for collection of abdominal fats (epididymis fat, perirenal fat, mesenterium fat, and retroperitoneum fat) and weighing.

TABLE 2

| | | | | Comparative | | Comparative |
|---|---|---|---|---|---|---|
| Test Food Group | HF | A-1 | A-2 | Example 1 | A-3 | Example 2 |
| Test Food | HF Food | HF Food | HF Food | HF Food | HF Food | HF Food |
| | | + | + | + | + | + |
| | | Invention product | Invention | Comparative | Invention | Comparative |
| | | 1 | product 2 | product | product 2 | product |
| Casein | 20 | 20 | 20 | 20 | 20 | 20 |
| Galatinized potato starch | 28.5 | 28 | 28 | 28 | 28.2 | 28.2 |
| Saccharose | 13 | 13 | 13 | 13 | 13 | 13 |
| Oil/Fat | 20 | 20 | 20 | 20 | 20 | 20 |
| Lard | 10 | 10 | 10 | 10 | 10 | 10 |
| Cellulose | 4 | 4 | 4 | 4 | 4 | 4 |
| Mineral mixture | 3.5 | 3.5 | 3.5 | 3.5 | 3.5 | 3.5 |
| Vitamin mixture | 1 | 1 | 1 | 1 | 1 | 1 |
| Composition of Example 1 | — | 0.52 | 0.52 | 0.52 | 0.26 | 0.26 |

HF Food: High fat/high saccharose food

The body weight gain and the amount of abdominal fat as measured 11 weeks after start of ingesting respective test foods are shown in Table 3, in which the body weight gain (increment from the body weight as measured before start of test) and the amount of abdominal fat found in the HF food ingestion group (i.e., high fat/high saccharide ingestion group) are taken as 100.

TABLE 3

| Test Food Group | Body Weight Gain | Amount of Abdominal Fat |
|---|---|---|
| HF | 100 (22.42) | 100 (11.12) |
| A-1 | 81.01 (22.53) | 71.46 (22.05)* |
| A-2 | 79.46 (18.7)* | 66.74 (21.44)** |
| Comp. Ex. 1 | 87.22 (34.73) | 74.78 (34.21) |
| A-3 | 80.59 (24.01) | 65.24 (30.8)* |
| Comp. Ex. 2 | 95.67 (28.63) | 81.23 (29.73) |

Note)
Relative values (standard deviation values) on the basis of the data from the HF food group being taken as 100.
Test of significance (with respect to the HF food group):
*p < 0.05
**p < 0.01

As is apparent from Tables 2 and 3, the representative compositions of the present invention, in which catechins and gallic acid are contained at specific proportions [(A-1), (A-2), and (A-3)], exhibit excellent obesity preventive effect, in particular, effect of reducing abdominal fat, as compared with the compositions of Comparative Examples 1 and 2, which contain catechins but the gallic acid content is insignificant.

### Example 3

Intensity of Bitterness of Hydrolyzed Catechin

The intensity of bitterness of each of the compositions prepared in Example 1 was determined through a sensory test. The test method employed is the “bitterness intensity test method” employing a quinine sulfate as an index (see “Perception and Psychophysics,” 5, 1969, 347-351; Sensory Test Handbook (New Edition), edited by the Sensory Test Committee, JUSE Press, Ltd., pp. 448-449). Briefly, respective test specimens are compared with standard solutions of quinine sulfate having different levels of bitterness (10 levels), and a standard solution exhibiting a bitterness equivalent to that of the specimen is chosen. Five panelists participated in the sensory test. The results of the sensory test were averaged. and expressed as bitterness intensity values τ. Table 4 shows the relation between concentration of quinine sulfate and value τ.

In the evaluation test, catechin hydrolyzates contained in the compositions of Example 1 were dissolved in a medium so that the total catechin concentration was 100 mg/100 mL, and the pH of the resultant solution was adjusted to 6.0 by use of sodium bicarbonate, to thereby prepare a specimen for evaluation.

TABLE 4
Concentration of Bitter Substance Contained
in Bitterness Standard Solution and τ Value

| | Quinine Sulfate Dihydrate |
|---|---|
| τ Value | (g/100 mL; aqueous solution) |
| 1.0 | 0.00023 |
| 1.5 | 0.00050 |
| 2.0 | 0.00094 |
| 2.5 | 0.00157 |
| 3.0 | 0.00241 |
| 3.5 | 0.00388 |
| 4.0 | 0.00608 |
| 4.5 | 0.00985 |
| 5.0 | 0.01572 |
| 5.5 | 0.02568 |

Evaluation specimens and results of evaluation performed on ordinary beverages are shown in Table 5.

TABLE 5
Intensity of Bitterness

| | Invention | Invention | Comparative |
|---|---|---|---|
| | Product 1 | Product 2 | Product 1 |
| Total Catechin Concentration | 100 | 100 | 100 |
| (mg/100 mL) | | | |
| Bittemess (τ Value) | 3.3 | 2.0 | 4.8 |

As is apparent from Table 5, since the proportions by weight of components (A) and (B) fall within a predetermined range, Invention Products 1 and 2 exhibited significantly mitigated bitterness, despite the fact that they contained the same amount of catechins as Comparative Product 1.

### Example 4

### Beverage in Container

| Barley tea extract | 99.47 (wt %) |
|---|---|
| Product of Example 1 (Invention Product 1) | 0.46 |
| Perfume | 0.05 |
| Vitamin C | 0.02 |

The pH of a mixture prepared from the above ingredients was adjusted to 5.8 by use of sodium bicarbonate, and the mixture was placed in a steel can (340 rnL) at 80° C., followed by sterilization at 121° C. for 15 minutes, to thereby yield a canned beverage. The non-polymerized catechin content and gallic acid content of the beverage were found to be 1,430 ppm and 156 ppm, respectively.

### Example 5

### Beverage in Container

| High fructose corn syrup (Bx75)¹⁾ | 6.8 (wt %) |
|---|---|
| Granulated sugar | 1.2 |
| Product of Example 1 (Invention Product 2) | 0.21 |
| Citric acid | 0.18 |
| Trisodium citrate | 0.1 |
| Vitamin C | 0.05 |
| Sodium chloride | 0.07 |
| Potassium chloride | 0.04 |
| Magnesium chloride | 0.01 |
| Calcium lactate | 0.03 |
| Glutamic acid | 0.015 |
| Perfume | 0.01 |
| Water | balance |
| Total | 100 |

¹⁾Refractometric Brix

A mixture prepared from the above ingredients was instantaneously sterilized at 90° C. or more, and placed in a PET bottle (500 mL) at 88° C., to thereby obtain a hot-packed beverage. The non-polymerized catechin content and gallic acid content of the beverage were found to be 600 ppm and 120 ppm, respectively, and the amount of ingested catechin per serving (500 mL) was 300 mg as reduced to non-polymerized catechins.

### Example 6

### Soft Capsules

<Composition of the soft capsule shell>

| Gelatin | 70 (wt %) |
|---|---|
| Glycerin | 22.9 |
| Methyl p-hydroxybenzoate | 0.15 |
| Propyl p-hydroxybenzoate | 0.51 |
| Water | 6.44 |
| Total | 100 |

Shells for soft capsules (oval shape, 150 mg) formed from the above ingredients were charged with 540 mg of polyphenols having a catechin content of 80 wt % and 85 mg of gallic acid, to thereby prepare soft capsules.

### Example 7

### Soft Capsules

Shells for soft capsules of the same type as those of Example 6 were charged with 400 mg of the catechin hydrolyzate (Invention Product 2) prepared in Example 1, to thereby prepare soft capsules.

### Example 8

### Baked Cake

| Product of Example 1 (Invention Product 1) | 0.85 (g) |
|---|---|
| Cornstarch | 20 |
| Wheat Flour | 50 |
| Butter | 5 |
| Fructose | 14 |
| Sodium chloride | 0.5 |
| Sodium bicarbonate | 0.5 |
| Water | 10 |

The above ingredients were mixed, to thereby prepare a baked cake.

The food products of the present invention are very safe and exhibit excellent anti-obesity effect. Reduced amounts of ingestion achieves satisfactory obesity-preventive effects. Their tastes are so attractive as to ensure daily ingestion by consumers.

Obviously, numerous modifications and variations of the present invention are possible in light of the above teachings. It is therefore to be understood that within the scope of the appended claims, the invention may be practiced otherwise than as specifically described herein.

This application is based on Japanese patent application Nos. 2001-146169 and 2002-078718 filed in the Japanese Patent Office on May 16, 2001 and Mar. 20, 2002 respectively, the entire contents of which are hereby incorporated by reference.

1. A food product comprising the following non-polymerized components (A) and (B):
(A) catechins in an amount of at least 200 ppm
(B) gallic acid or a salt thereof wherein a ratio by weight (B)/{(A)+(B)} is 0.08 to 0.6.

2. The food product of claim 1, wherein component (A) is selected from the group consisting of catechin, gallocatechin, catechin gal late, gallocatechin gall ate, epicatechin, epigallocatechin, epicatechin gallate, epigallocatechin gallate and a mixture thereof.

3. The food product of claim 1, wherein component (A) is selected from the group consisting of catechin, gallocatechin, epicatechin, epigallocatechin and a mixture thereof.

4. The food product of claim 1, wherein component (A) is a non-gallic catechin.

5. The food product of claim 1, wherein component (A) is present in an amount of 400 ppm or more.

6. The food product of claim 1, wherein component (A) is present in an amount of 600 ppm or more.

7. The food product of claim 1 wherein component (B) is a hydrolyzate of catechin gallate.

8. The food product of claim 1, wherein component (B) is present in an amount of 18 ppm or more.

9. The food product of claim 1, wherein component (A) is present in an amount of 35 ppm or more.

10. The food product of claim 1, wherein component (A) is present in an amount of at most 53 ppm.

11. The food product of claim 1, wherein a ratio by weight (B)/{(A)+(B)} is 0.1 to 0.6.

12. The food product of claim 1, wherein a ratio by weight (B)/{(A)+(B)} is 0.2 to 0.6.

13. The food product of claim 1 wherein component (B) is a tannase treatment product of tea leaves.

14. The food product of claim 1, wherein a ratio of the total weight of catechins and gallic acid to the total weight of polyphenols is 0.5 to 0.99.

15. The food product of claim 1, wherein a total polyphenol content is 400 ppm or more.

16. The food product of claim 1, wherein the total weight of catechins and gallic acid per serving is 250 to 1,000 mg.

17. The food product of claim 1 which is a beverage contained in a container.

18. An anti-obesity agent comprising, as an active ingredient, the following non-polymerized components (A) and (B):
(A) catechins in an amount of at least 200 ppm
(B) gallic acid or a salt thereof wherein a ratio by weight (B)/{(A)+(B)} is 0.08 to 0.6.
